(19) United States
(12) Patent Application Publication
(10) Pub. No.: US 2014/0036085 A1
(43) Pub. Date: Feb. 6, 2014

(54) Monitoring System

(71) Applicants: Bruno Avignon, BUC (FR); Lionel Thomas, Le Perray En Yvelines (FR)

(72) Inventors: Bruno Avignon, BUC (FR); Lionel Thomas, Le Perray En Yvelines (FR)

(21) Appl. No.: 14/006,564

(22) PCT Filed: Mar. 22, 2012
(86) PCT No.: PCT/IB2012/000574

§ 371 Date: Sep. 20, 2013

(30) Foreign Application Priority Data
Mar. 22, 2011 (FR) 11 00861

(51) Int. Cl. H04N 7/18

(52) U.S. Cl. CPC H04N 7/181
USPC 348/153

(57) ABSTRACT

A surveillance system includes presence detectors in a given area and an intruder identification system. The detectors are distributed among different mobile monitoring stations. A network is formed by the monitoring stations and a management unit which is designed to communicate with each of the monitoring stations and has software designed to automatically calculate the configuration to be given to the network which is to monitor the area and thus optimise the equipment used in each sector. The network configuration is calculated according to input data which include pre-recorded characteristics in the management unit and data that are at least partly provided by the monitoring stations once they are installed in the area.

### FIELD OF THE INVENTION

This invention concerns a surveillance system designed to detect the presence of intruders in a given area.

### BACKGROUND OF THE INVENTION

In the field of intrusion detection, the use of optronics, unlike radar which only generates an alert that can be difficult to interpret, enables users to immediately determine whether the intrusion is benign or not, usually by combining data from an optical sensor with an image processing system and a system which displays or memorises data from the image processing system.

Surveillance systems can be used in numerous applications such as border control, industrial facilities and construction sites. Surveillance systems exist which comprise look-out towers at the top of which a video camera widely scans the area to be monitored. While this type of system provides long-distance visibility when the surrounding area is flat, the presence of obstacles such as mountains and buildings in the vicinity of the towers complicates surveillance operations by requiring very high towers in particular.

### SUMMARY OF THE INVENTION

The present invention is aimed at using mobile surveillance equipment in easy-to-implement installations to offer reliable operation while keeping construction and operating costs to a minimum. Due to the mobility of the equipment and the fact that it is managed and controlled throughout operation, surveillance is discreet, effectively indicating the presence of an intruder while remaining undetectable.

The principle of the invention, whether it takes the form of a process or equipment, is to propose a new surveillance technique that eliminates the drawbacks mentioned above, and which is both easy to implement and reliable.

According to the invention, the surveillance system comprises a network of monitoring stations each equipped with a detector in which the said monitoring stations are arranged according to a network configuration which is calculated automatically by software in a management unit which is part of the network and has a permanent radio link to the monitoring stations.

The initial position of each monitoring station is determined automatically by calculation, based on pre-recorded characteristics in the management unit. The initial position can be updated automatically by the management unit based on data received by the latter in real time relating to the effective positioning and operation of the monitoring stations.

This results in a particularly effective surveillance system because the position of the monitoring stations takes both practical and theoretical constraints into account whether they are material or geographical, and the position can be modified without compromising the system, since the best network configuration is calculated in real time regardless of any changes that may be made to any of the components in the network.

The pre-recorded characteristics can take the form of either a three-dimensional map of the area to be monitored or that of the technical characteristics of each detector used. The geographical relief and any compulsory crossing points are used to place the detectors at locations that best correspond to their operating characteristics. It is then particularly advantageous for the management unit to be able to calculate the position of the monitoring stations and detectors so that, for example, cameras with a smaller scan can be used to monitor a narrow path and cameras with a wider scan can be used to monitor flat open country.

Calculation of the network configuration mainly consists in determining the location of each monitoring station in relation to the others and to the management unit. It also determines the operating data to be respected by each detector and intruder identification system. The software in the management unit also enables an optimised network to be configured so that the area to be monitored is covered by all the detectors, respecting, where necessary, conditions imposed by strategical considerations such as calculating the scanning areas of two neighbouring detectors so that they overlap in order to ensure redundancy at certain points of the area to be monitored.

It should be noted that it is not the presence detection data that are used to calculate the new network configuration in real time, but the location and the operating data relating to the monitoring stations. The aim according to the invention is to propose an optimised surveillance network for the detection of intruders and it is advantageous to modify the network configuration before the appearance of an intruder in order to provide an optimised network to ensure detection of the presence of the said intruder.

According to a particularly advantageous feature of the invention, the management unit communicates in real time with each of the monitoring stations, in particular to receive data concerning the effective location of the monitoring stations or operation of the detectors; a new network configuration is calculated in real time when any of the data received are different from those corresponding to the network configuration calculated previously. Thus, it is possible to adapt the network configuration to actual conditions in the field, or to the failure of one of the detectors. For example, it may not be possible to place one of the network stations at the required location for reasons that were not detected in the 3-D map study conducted by the management unit, such as the presence of high winds on an open plateau which could penalise the measurements. It could happen that a monitoring station is placed correctly with respect to the network configuration initially calculated but that the detectors associated with the station send information to the management unit that an obstacle is hindering visibility. The network configuration is then automatically recalculated and any monitoring stations that have not yet been installed are allocated new initial positions.

According to different characteristic features of the invention:
communication equipment enabling data exchanges between monitoring stations and the management unit comprises a transmitter-receiver for low bandwidth communications with the management unit and a transmitter for high bandwidth communications with the management unit. It can thus be observed that low bandwidth communications allow exchanges in both directions between the management unit and the monitoring stations, particularly for real time calculation of an efficient network configuration, while high bandwidth communications take place in the other direction, from the monitoring station to the management unit, particularly for the transmission of video data used by the operator to check images in the area to be monitored in real time. Advantageously, these two types of radio links can be used for different purposes, with the low bandwidth link used continuously and omnidirectionally when the beacon is fully extended while the high bandwidth link is only used occasionally when an alert is given via the low bandwidth link. The high bandwidth link transmitter can be directed towards the management unit during transmission then retracted until the next time it is needed, which is particularly useful for increasing the operating time of the beacon.
the management unit is located onboard a mobile unit which is designed to be displaced while each monitoring station is being installed in the initial location determined by the management unit and withdrawn after all the stations in the network have been installed.

Due to its different characteristic features, as briefly defined above or defined and illustrated below, such that they can be advantageously implemented in an industrial context, either separately or in each of its technically effective combinations, the invention provides a particularly reliable surveillance system that can be adapted to all types of terrain whatever the relief, since the said system can be displaced or reconfigured, both regularly to surprise intruders and rapidly so as not to create dangerous situations when installing the monitoring stations, with very precise instructions in order to respect the network configuration calculated to facilitate intrusion detection.

### BRIEF DESCRIPTION OF THE DRAWINGS

The invention will now be more completely described in relation to its preferred characteristic features and their advantages, referring to FIGS. 1 to 3, in which:

FIG. 1 represents a surveillance system according to the invention, in which a management unit and several monitoring stations form a network to detect intrusion in a given area;

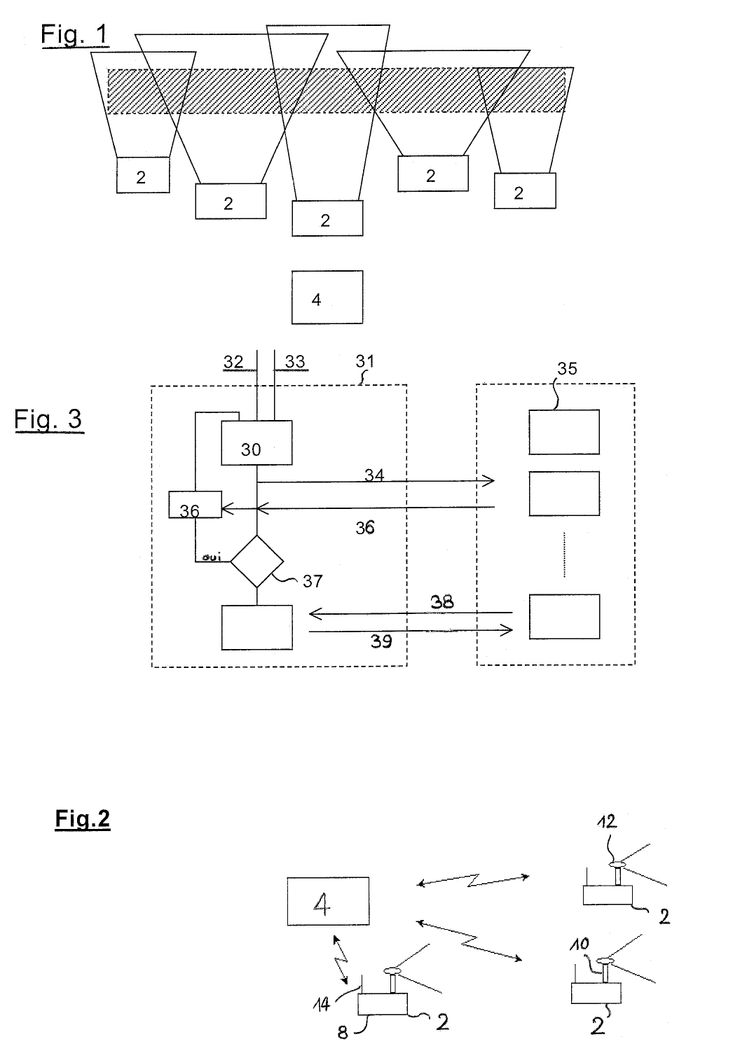

FIG. 2 diagrammatically illustrates communications between the management unit and some of the monitoring stations in the network illustrated in FIG. 1;
and FIG. 3 is a block diagram representing the surveillance process according to the invention.

### DETAILED DESCRIPTION OF THE INVENTION

The surveillance system represented in FIG. 1 comprises a network of monitoring stations 2 arranged to completely cover a given area, and a management unit 4 located at a distance from the monitoring stations and designed to communicate with each of them.

In the construction method depicted, the management unit is able to communicate with five monitoring stations. Advantageously, a management unit accommodates four to six monitoring stations. It is understood that the number of monitoring stations is a strategic rather than a technical choice and that, as a result, the invention is not limited to the number of management units and monitoring stations shown here. In the case mentioned, the area to be monitored, represented by the shaded area in FIG. 1, roughly covers a linear distance of fifty kilometres in which the system must detect and identify intrusions and crossings. The depth of the area to be monitored is determined so that visual confirmation of the alert can be carried out before the intruder has finished crossing the area being monitored.

Each monitoring station has at least one beacon mounted on a base 8, together with standalone power supplies and equipment for communicating with the management unit, with the said monitoring station being mobile due to the possibility of displacing the base to adjust the position of the monitoring station with respect to its initial location in the defined area.

The beacon is retractable. It comprises a telescopic mast 10, at the free end of which there is a detection head 12.

The mast 10 is mounted in the base such that the beacon can go from retracted position in which it is totally lodged in the base and thus protected from inclement weather and assailants, to fully extended position in which the head is raised to a height of two metres above ground, for example, and can be bent at an angle.

The head 12 incorporates the detectors required for presence detection in the area to be monitored, which can take the form of one or several cameras comprising high definition identification equipment such as a high resolution camera. The presence of different cameras means that several frequency bands can be used, such as visible, near infrared and infrared in the VHF BII and BIII bands. The head can also be equipped with a directional microphone and other types of sensors and measuring devices known for this type of use, such as radar. As described below in the section on how to use the system, it is advantageous to equip the detector head with a laser telemeter and a laser pointer. The head can also be equipped with a north seeker so that the sensors and cameras can be pointed in the required direction.

The beacons will also be equipped with an intense light production device, of the photographic flash type, for the particularly advantageous use of active imagery described below.

It should be noted that according to the invention, two monitoring stations in the same network can have different measuring devices or measuring devices with different characteristics. The cameras could have different direct vision ranges and scanning speeds, for example. As described later, it would be interesting according to the invention to use different types of detectors in the same network so as to adapt to variations in relief or terrain in the area to be monitored. By way of example, a monitoring station could incorporate a localisation radar to scan a large plain that is less sensitive to atmospheric conditions than the optronic detectors on the other monitoring stations in the system.

The base is in the form of a box at the bottom of which the articulated telescopic mast is mounted. Inside the box, in addition to the beacon, there are at least one satellite-based geolocation device, one calculation module and radio communication equipment 14 designed to allow communication between the monitoring station and the management unit and between monitoring stations.

The calculation module incorporates automatic intrusion detection software which receives all the measurements taken by the on-board apparatus on the detection head associated with the said monitoring station. The calculation module can be configured during implementation of the monitoring station for better alert selectivity according to the terrain in which it is installed by the operator and, as described below, the management unit can send module configuration changes during operation. The calculation module also carries out a local backup, for example, using a sliding window to record the last few minutes of video received by the cameras and analysed by the software. Advantageously, the calculation module incorporates an image processing function so that it can receive images taken by the camera mounted on the head associated with the monitoring station and process them so that the resulting very high definition fixed image can subsequently be studied to ensure that the alert is correct.

The communication equipment comprises a radio transmitter-receiver to ensure a low bandwidth link and a radio transmitter and multi-directional antenna combined to ensure high bandwidth transmission to the management unit. Advantageously, the data relating to operation of the detectors and the location of the monitoring station, which are designed to be sent in one direction or the other between the management unit and the monitoring station, are transmitted at high bandwidth, using, for example, a GSM or 3G network, or high (HF) or very high (VHF) radio frequencies. The videos, for their part, are sent in one direction from the monitoring station to the management unit at high bandwidth, using, for example, WIMAX transmission mode. For this purpose a video compression module will be included in the base to support the said transmission.

Advantageously, the low bandwidth radio transmitter-receiver consists of a fixed antenna which emits omnidirectionally while the high bandwidth communication equipment consists of a directional antenna with a high electromagnetic gain which is only triggered occasionally, depending on the content of the communications between the radio transmitter-receiver and the management unit. The directional antenna is thus directed towards the management unit only and becomes operational when a potential intrusion is detected by the beacon, which saves energy and gives the beacon greater autonomy.

The equipment used for communications between the management unit and the monitoring stations takes existing networks into account as alternative links in the case of failure of HF and VHF on-board radio communications. In this case, the transmission quality adapts to the capacity of the available transmission networks.

Advantageously, the base is designed to accommodate, in addition to the beacon, equipment for detecting the close presence of intruders in order to be able to automatically launch a self-protection operation, without the prior intervention of the monitoring station, which consists in retracting the antenna as described previously when approached by an intruder who might see the station if the antenna is in the extended position. A passive infrared (PIR) motion detector can be used, for example, with a range of fifty metres, or a radar detector or a seismic detector.

Other equipment can be used and the monitoring station equipped, in particular, with a self-destruction mechanism placed in the base.

The base has a standalone power supply, such as photovoltaic cells, and can include a consumable energy source such as a power generator or a fuel cell system. The base has a camouflage covering and is designed to be as discreet as possible, with the aim of providing a stand-alone, discreet monitoring station.

An automatic levelling device adjusts the position of the base so that the monitoring station is located according to the specified network configuration. For this purpose, the base has four legs mounted on jacks, each being designed to be extended individually so as to adjust the position of the base according to the slope of the terrain on which it has been installed.

During operation, the presence detection capacity of the beacon in a monitoring station can vary according to the type of sensors present and external conditions such as daytime visibility and relief. The automatic detection software processes data from the sensors to determine whether or not there is an intrusion. It must therefore be capable of distinguishing a vehicle from a human being and providing the distance at which the intruder is located. In certain cases, it must be possible to give precise details such as the presence of a weapon. This detection sensitivity is made possible by a larger number of sensors in the beacon head.

As described below, each intrusion detected is indicated by the transmitter-receiver, which exchanges low bandwidth communications with the management unit so that the detection of an intruder can be checked and identified by the operator if necessary and, in return, the detection beacon can be remotely controlled from the management unit.

It should be noted that the presence detection communications sent to the management unit are different from the monitoring centre positioning and operating communications which are also sent to the management unit.

The content of the low bandwidth communications relating to the positioning and operation of monitoring stations is used by the management unit to calculate a new network configuration while the content of the low bandwidth communications relating to presence detection triggers operation of the mobile antenna on the telescopic mast to send video data to the management unit. It should be noted that the antenna is mounted on the mast so that it can turn independently of the head and always face in the direction of the management unit while the head faces the intruder.

The management unit is placed as far as possible from the monitoring stations so that it will not be detected by intruders in the area being monitored, while at the same time maintaining communication with each of the monitoring stations.

The management unit is placed onboard a distribution vehicle whose mobility enables the monitoring stations to be rapidly installed and withdrawn as soon as a new area is to be monitored and for the management unit to be rapidly positioned outside the area to be monitored and at an equal distance from the beacons once the monitoring stations have been installed. The distribution vehicle is equipped with lifting equipment to displace the monitoring stations. It also has a satellite-based geolocation device.

The management unit includes a computer. Within the framework of a surveillance operation, the computer plays a role in preparing for the operation by calculating the network configuration. It also plays a role during the surveillance operation, through interaction with the monitoring stations located in the field and by automatic calculation in real time of a new network configuration when necessary, which can lead to a change of position in the case of stations that have not yet been installed in the field and to the remote control of beacons that are already in place.

The monitoring stations are positioned in relation to each other and to the management unit according to a network configuration defined by the management unit's computer software. The network configuration takes into consideration the technical characteristics of the detectors available so that they can be positioned according to a 3D map of the area to be monitored. The software can incorporate a wave propagation calculation algorithm to ensure that the theoretical layout of the beacons allows communication between the antennas and the management unit.

Depending on the data exchanged continuously between each beacon, by means of its fixed antenna, and the management unit, the network configuration can evolve in real time: the position of the beacons can be changed, particularly those that haven't been installed and are still onboard the vehicle; the operating mode of the detectors associated with each beacon can be changed remotely.

In particular, when setting up a network of beacons in mountainous areas where the perspective is not linear, the beacons can be calibrated again when being installed on the ground to ensure that the detection criteria on which the beacon's 3D-image processing system is based, and which refers to the theoretical mapping data, are still consistent. The laser telemeter is used to point at a fixed point on the landscape and communicate the distance between the beacon and the fixed point to the management unit via the antenna. The management unit uses the fixed point to determine whether the detection criteria need to be changed and, for example, the size of the pixels to be detected on the photographs.

It should be observed here that a distinction should be made between the detectors' technical characteristics and their operating data. The technical characteristics are the values entered in the management unit computer and are the maximum or minimum values stipulated by the manufacturer for the detectors concerned. The operating data are the values measured directly by the detectors or the values that the computer wants to impose upon the detectors within the ranges allowed by the technical characteristics.

The computer receives information in real time concerning the effective position of the monitoring stations and whether the beacons are retracted or fully extended for each monitoring station, as well as the detectors' operating data. The said data are immediately used by the software to calculate the new network configuration.

Thus, according to the invention, the software automatically calculates a new network configuration according to the data received in real time, in order to adapt to any changes that may occur during surveillance.

The choice of the exact location of the monitoring stations, like that of the detector operating data, is thus assisted by the software which is an integral part of the system and also enables the theoretical positioning to be adapted to the actual conditions in the field discovered in real time.

The software receives pre-recorded data such as a 3D map of the area to be monitored and all the strategical considerations associated with the map, that is, for example, the importance of a particular passage in the area to be monitored or, on the contrary, the possibility of not having to monitor some parts of the area because they cannot be accessed by intruders. The pre-recorded data also include all the technical characteristics of the detectors available to carry out the surveillance operation. Examples of such characteristics are the height to which the beacon head can be extended, the maximum range of the cameras, their scanning speed, angle and number of pixels, but other characteristics can obviously be used while remaining within the framework of the invention.

The criteria to be respected by the software when determining the network configuration can include the fact that two neighbouring beacons have overlapping scanning areas to afford a better view of sectors that are considered to be sensitive and thus provide better detection of potential intruders.

The management unit also comprises communication equipment designed to correspond with the communication equipment 14 associated with the monitoring stations, particularly to receive intrusion detection alerts. The first type of communication equipment is designed to exchange data at low bandwidth with the monitoring stations almost continuously, while the second type of communication equipment is designed to occasionally receive high bandwidth data from the monitoring stations. As soon as an alert is received, an operator in the management unit can interact remotely with the monitoring station(s) identified as being responsible for the alert, and intervene remotely in order to manually change the direction of the detectors and acquire additional data. The management unit has the necessary means for local back-up of data from each of the monitoring stations.

We will now describe the use of the invention, based in particular on the diagrams in FIG. 3.

The 3D map 32 corresponding to the area to be monitored and the technical characteristics 33 of the detectors are entered in the computer 30 of the management unit 31. The computer's software calculates a precise network configuration 34, defining the number and position of the monitoring stations 35 to be installed to cover the area.

All the monitoring stations required are placed in the distribution vehicle, with their beacons in retracted position. The distribution vehicle takes each of the monitoring stations to the location in the network configuration determined by the software and places it in the corresponding position.

During displacement of the distribution vehicle, the management unit may be only partially operational, with, for example, the IT system being operational but the transmission equipment being in failsoft mode while the onboard beacons are at a standstill or being recharged.

If all the monitoring stations are strictly located in the initial position determined, the distribution vehicle can leave the area and go to the location designated by the software so that the management unit that has remained onboard the vehicle will be positioned correctly with respect to the monitoring stations so as to receive alerts from the stations.

However, it could frequently happen that one of the monitoring stations cannot be installed in the position allocated by the software. For example, flora which was not taken into account by the software because it is not included in the input data provided by the 3-D map could prevent the beacon from being strictly located in the allocated position. The case could also arise of a potentially dangerous situation in which the driver of the distribution vehicle considers that he would be too exposed if he tried to install the monitoring station in the exact position allocated, preferring to place the monitoring station a few metres farther on rather than jeopardise his safety.

In the system according to the invention, the said monitoring station, which sends data 36 on its position to the management unit in real time, together with the detector operating data, is assigned a precise location. Since in the present case, there is an affirmative answer to question 37 as to whether the network configuration initially calculated has been changed, the software associated with the management unit incorporates the said data 36 in real time to automatically recalculate the network configuration while respecting the calculation criteria provided, that is, to ensure that the area to be monitored is completely covered, with overlapping of beacons.

It is particularly advantageous according to the invention to be able to use data from monitoring stations already installed, which complete the pre-recorded data and provide additional input data to determine the network configuration using appropriate software. In this way, the management unit calculates the network configuration according to real constraints and not just theoretical ones. Specific information is sent to the management unit if the positions allocated to the monitoring stations that remain to be installed need to be modified. The management unit can also send information by low bandwidth radio communication to the beacons already installed in the field to automatically change the detector operating data and, for example, the direction of the detector head or the scanning conditions for the cameras in the beacon head.

The data sent to the beacons can also concern a change in the detection criteria such as the size of the pixels to be detected in a given area. Especially in the case of a network installation in mountainous regions, changing the location of a beacon by a few metres can considerably change the perspective of the photographs. The position of the beacon with respect to the different strategic areas of the theoretical map can then be checked. The detection head is controlled remotely from the management unit and the laser telemeter is pointed towards a fixed point in the landscape. The beacon detection criteria for the fixed point can thus be recalibrated, which is particularly interesting, for example, in the case of surveillance of a winding mountain path where a person will seem smaller when they are at the bottom of the path. The position can be checked by laser telemeter at the request of the management unit at any time, even if the beacon is placed in its exact theoretical position.

As soon as they are installed and in the extended position, whether by manual control during installation or remotely via the management unit, the beacons automatically start monitoring the area they are supposed to cover. The area to be covered can be adjusted according to practical constraints, either by configuration before the beacons are extended and/or by retouches during operation via the low bandwidth connection between the monitoring stations and the management unit. At the request of the management unit, particularly if an intruder is identified by an operator and is judged to be a threat to the monitoring station, the beacon can be placed in security mode, that is, in retracted position inside the base.

In the case of an alert, a signal 38 is emitted by a low bandwidth link to the management unit onboard the distribution vehicle. The signal contains alert classification elements as well as the location of the part of the area in which the alert occurred. At the same time, the video of the sliding window which contains the sequence that produced the alert is saved. The high bandwidth transmitter starts operating with the associated antenna facing the management unit, using the satellite coordinates from the geolocation devices in the monitoring station and distribution vehicle. The video is relayed to the management unit in real time. The operator can then take manual control 39 of the beacon using a control lever and displace the beacon cameras as required to scrutinise the part of the monitored area in which a potential intruder has been detected. If direct observation does not enable the pertinence of an alert to be determined, the operator can request the video of the sequence that led to the detection of an intruder or access to the photograph taken at the time of detection to see how it was processed by the monitoring station calculation module.

The use of videos and/or photographs is of considerable interest here for the operator who can thus determine the pertinence of the alert and decide on the extent of the action to be undertaken with greater precision than that afforded by radar control. The operator can then decide to send an intervention team to the site for example. When an intruder has been reported, the operator can geolocate them by determining their position with respect to a monitoring station using the laser telemeter in the beacon head. The operator can take an active part in the intruder interception phase by helping the intervention team, whose members are equipped with night-vision instruments, by illuminating the intruder with the laser pointer.

The description above clearly explains how the invention is able to achieve its objectives. The software incorporated into the management unit's computer automatically and very rapidly calculates the network configuration despite the many constraints to be taken into consideration. As set out above, it also enables the theoretical plans to be adapted to the actual constraints in the field, using real time automatic calculation. The surveillance system is therefore particularly efficient because the software is able to organise a new beacon distribution or at least new operating data for the detectors in each of the monitoring stations as soon as one of the monitoring stations is displaced, concealed, placed in standby mode or destroyed. The surveillance system is rapid to implement and displace, and the system can be installed and operated by a team of two people. The surveillance system is safe for the operator, because the management unit is onboard a four-wheel drive vehicle that can implement the monitoring stations and interact with them, regardless of the operating conditions. This enables a regular patrol team of two people to keep a wide strip of land under continuous surveillance and in complete safety. The beacons in the surveillance system can operate for a week without intervention while the management unit needs to be recharged only once a day.

The surveillance system according to the invention is modular, particularly with regard to the type of beacons used. Different measurements can be taken by a monitoring station and its neighbouring station, depending on the section to be monitored, and, for the same measurement, different detection technologies can be incorporated into the different monitoring stations.

If cheaper optronic captors are to be used on any of the stations, the efficiency of the system will be maintained by increasing the number of monitoring stations and/or completing the equipment with other types of sensors.

The above network layout is particularly useful when a beacon has detected a potential intruder at night or in the presence of fog. Active imaging of the area is then recommended; this consists in taking photographs and floodlighting the area. According to the invention, the lighting capabilities of several beacons are pooled to provide floodlighting and enable other photographs to be taken by one of the other beacons. The management unit receives information on a possible intrusion and the existence of reduced visibility via light sensors onboard the beacon, for example. The extent of the area in which the intrusion has been detected is estimated by the laser telemeter of the beacon that detected the intrusion. The information is sent to the beacons, directly or by the management unit, via the fixed antenna, and the neighbouring beacons turn on their lighting devices in order to floodlight the determined area. Thus, the beacon's capabilities are pooled when the beacon detects an intruder under low visibility conditions such as night-time or fog. The optical effect of active imaging is reproduced without the added complexity of ultra-precise time synchronisation of the light source. The video from the camera which is also built into the detection and identification head can be used to identify the intruder despite its lower resolution, particularly to obtain information on the subject's behaviour.

In a variant not represented here, it can be seen that the management unit is not necessarily onboard the distribution vehicle during the surveillance operations but can be kept in a control camp that centralises information. A system can be envisaged with several control camps and several management units, with the monitoring stations being placed in a customer-server network.

Other variants can be envisaged, as a result of which the invention is not limited to the implementation method specifically described and represented in the figures.

1. A surveillance system for a pre-determined area comprising presence detectors divided up among various mobile monitoring stations which are organised in relation to each other and to a management unit forming a network according to an initial configuration defined theoretically by software in said management unit,
said management unit being designed to communicate in real time with each of the monitoring stations in order to receive positioning and operating data as well as presence detection data from said monitoring stations,
and said software being designed to use pre-recorded characteristics to calculate the initial network configuration, allocating an initial location to each of said stations, and to automatically calculate in real time a new configuration to be allocated to the network in order to monitor said area, according to said pre-recorded characteristics in the management unit and said positioning and operating data transmitted in real time by said monitoring stations implemented in said area.

2. The surveillance system according to claim 1, wherein the pre-recorded characteristics comprise a three-dimensional map of the defined area and technical characteristics of each detector.

3. The surveillance system according to claim 1, wherein order to calculate said configuration to be given to the network, the software is designed to calculate the position of all the monitoring stations in relation to each other and to the management unit.

4. The surveillance system according to claim 1, wherein order to calculate the configuration to be given to the network, software is designed to calculate the operating data of all the detectors in relation to each other.

5. The surveillance system according to claim 1, wherein said data received by the management unit comprises data relating to the effective position of the monitoring stations, said management unit being designed to calculate a new network configuration when one of the items of data received relates to a change of position of at least one of the monitoring stations in relation to the positions of the monitoring stations determined in the network configuration previously calculated by said management unit.

6. The surveillance system according to claim 1, wherein, said data received by the management unit comprise data relating to detector operating data, said management unit being designed to calculate a new configuration when one of the items of data received relates to a change in the operating data of at least one detector in relation to the detector operating data determined by the network configuration previously calculated by said management unit.

7. The surveillance system according to claim 1, wherein the monitoring stations comprise communication equipment including a transmitter-receiver designed to continuously exchange low bandwidth communications with the management unit and a transmitter for high bandwidth communications to the management unit, designed to be triggered according to the content of said low bandwidth communications.

8. The surveillance system according to claim 1, wherein the management unit is located onboard a distribution vehicle which is also equipped with handling gear to install the monitoring stations in the determined area.

9. A surveillance process performed by a presence detector network where each detector is designed to communicate with a management unit which is equipped with software designed to determine, at least, the position to be given to the detectors in a determined area, in which:
the initial configuration to be given to said network is calculated by the management unit, taking into account, at least, a theoretical three-dimensional map of said determined area;
data relating to an effective configuration of the network are obtained by communication between the detectors and the management unit;
a new network configuration is automatically calculated when one of said items of data recovered is modified in relation to the data concerning the network configuration previously calculated by said management unit;
data relating to the new network configuration are sent to the detectors.

10. The surveillance process according to claim 9, wherein said new network configuration consists in calculating new operating data for some or all of the detectors and the modified initial positions for any detectors remaining to be installed in the determined area.
